(19) United States
(12) Patent Application Publication
(10) Pub. No.: US 2020/0392696 A1
(43) Pub. Date: Dec. 17, 2020

(54) METHOD FOR OPERATING AN IMPLEMENT OF A WORK MACHINE

(71) Applicant: Caterpillar Inc., Deerfield, IL (US)

(72) Inventors: Tianjiao Zuo, Peoria, IL (US); Joseph Faivre, Edelstein, IL (US); Bradley Krone, Dunlap, IL (US); Steven Robert Krause, Chillicothe, IL (US)

(73) Assignee: Caterpillar Inc., Deerfield, IL (US)

(21) Appl. No.: 16/437,492

(22) Filed: Jun. 11, 2019

(51) Int. Cl. E02F 3/84; E02F 9/20

(52) U.S. Cl. CPC E02F 3/844; G05G 1/04; E02F 9/2041; E02F 9/2012

(57) ABSTRACT

A method for operating an implement of a work machine is disclosed. The method includes detecting a progression of an input device between a first position and a second position based on a first parameter and a second parameter; determining a plurality of segments of the progression; estimating a value of the second parameter of at least one first segment and at least one second segment; issuing a baseline signal to generate command to initiate manipulation of the implement if the value of the second parameter of the first segment complies with corresponding second parameter threshold condition; issuing a secondary signal to continue manipulation of the implement if the value of the second parameter of the second segment complies with corresponding second parameter threshold condition; and terminating the command if the value of the second parameter of at least one second segment violates the corresponding second parameter threshold condition.

### TECHNICAL FIELD

The present disclosure relates to a work machine having an implement operating at a worksite. More particularly, the present disclosure relates to a method for operating the implement of the work machine based on one or more gesture commands.

### BACKGROUND

Construction machines (also referred to as earthmoving machines), such as bulldozers, motor graders, skid-steer loaders, harvesters, paving machines, and the like, are used to alter a geography of a working surface, for example, to shape a plot of land into a desired ground profile. The construction machines may be equipped with one or more implements for accomplishing such operations.

Generally, said operations are accomplished by adjusting one or more parameters pertaining to the implement such as attitude, elevations, etc. via use of hand-operated controls such as joysticks or levers along with multiple push buttons provided within the construction machine. For example, an operator may use the hand-operated controls to manually adjust the implement position. However, manually adjusting the implement can be a complex and time-consuming task. For example, simultaneously controlling implement elevations and attitude may require a significant portion of the operator's attention.

To assist the operator in this regard, current construction machines are equipped with automatic implement control features. The automatic implement control features may be activated by inputting a single push button command or by inputting a combination of multiple push button commands. However, using multiple push buttons may require operators with high skill levels. Also, learning multiple push-button commands in order to activate the automatic implement control features not only takes time, but it may be counter-intuitive and may lead to inadvertent operational errors by the operators.

U.S. Pat. No. 7,530,185 relates to a backhoe loader which includes a controller configured to execute automatic blade return-to carry functions. The controller executes the automatic blade return-to-carry functions when the operator pushes or pulls the electronic joystick to physical detent positions in which the detent is felt which is, generally, at the end of travel of the joystick.

### SUMMARY OF THE INVENTION

In an aspect of the present disclosure, a method for operating an implement of a work machine is disclosed. The method includes detecting, by a controller, a progression of an input device between a first position and a second position based on a first parameter and a second parameter. The method further includes determining, by the controller, a plurality of segments of the progression based on one or more limits of the first parameter. Further, the method includes estimating, by the controller, a value of the second parameter corresponding to at least one first segment of the plurality of segments. Furthermore, the method includes issuing, by the controller, a baseline signal if the value of the second parameter corresponding to the at least one first segment complies with a second parameter threshold condition associated with the at least one first segment, and generating, by the controller, a command based on the baseline signal to initiate manipulation of the implement. The method also includes estimating, by the controller, a value of the second parameter corresponding to at least one second segment of the plurality of segments, wherein the at least one second segment is successive to the at least one first segment. Additionally, the method includes issuing, by the controller, a secondary signal if the value of the second parameter corresponding to the at least one second segment complies with a second parameter threshold condition associated with the at least one second segment to continue manipulation of the implement according to the command. In addition, the method includes terminating, by the controller, the command and the manipulation of the implement if the value of the second parameter corresponding to the at least one second segment violates the second parameter threshold condition associated with the at least one second segment.

### BRIEF DESCRIPTION OF THE DRAWINGS

FIG. 1 illustrates a work machine including an exemplary implement assembly, in accordance with an embodiment of the present disclosure;

FIG. 2 is a diagrammatic illustration of a user input device disposed within an operator cab (of the work machine of FIG. 1), and communicably coupled with an implement positioning system, in accordance with an embodiment of the present disclosure;

FIGS. 3A and 3B is a flowchart depicting an exemplary method of operating an implement of the work machine, in accordance with an embodiment of the present disclosure; and

FIGS. 4 to 7 are various graphical representations of operator input command signal and automatic implement manipulation command signal as a function of time, in accordance with an embodiment of the present disclosure.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

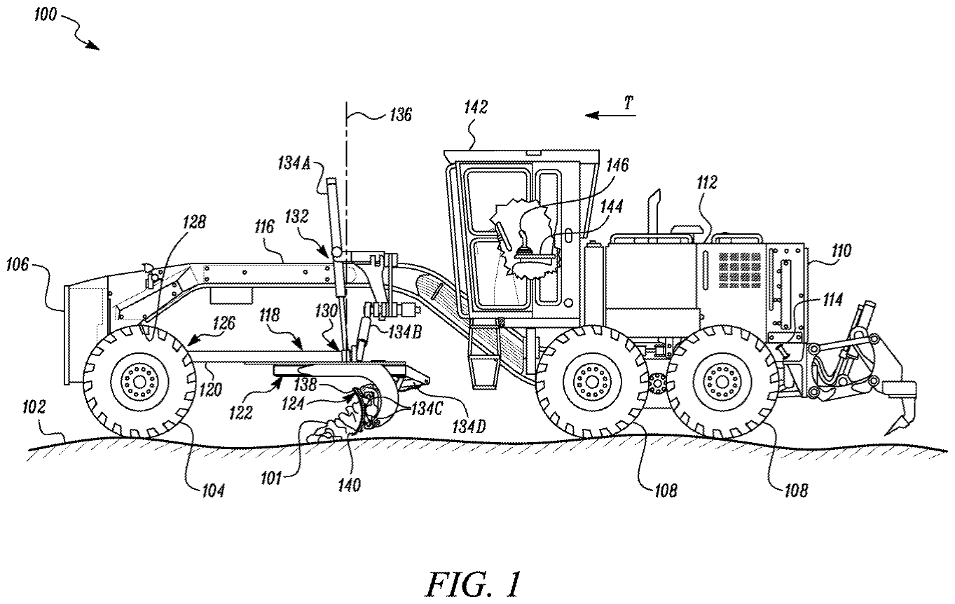

Referring to FIG. 1, a work machine 100 is shown, and as depicted, is a motor grader. While the work machine 100 has been shown to be a motor grader, it will be understood that in other embodiments, the work machine 100 may be a skid-steer loader, a backhoe-loader, a track or wheel type tractor or loader, a harvester, a paving machine, or any other type of construction, agricultural, or earth moving machine.

The work machine 100 may be used to displace, spread, distribute, level, and grade materials 101, such as soil, over a work surface 102. Generally, a grading operation is performed during machine movement, and for this purpose, the work machine 100 may include traction devices that facilitate movement over the work surface 102. For example, traction devices include a set of front wheels 104 disposed towards a front end 106 of the work machine 100 and a set of rear wheels 108 disposed towards a rear end 110 of the work machine 100. The terms ‘front’ and ‘rear’, as used herein, are in relation to a direction of travel of the work machine 100, as represented by arrow, T, in FIG. 1, with said direction of travel being exemplarily defined from the rear end 110 towards the front end 106. While in the illustration of FIG. 1, only one front wheel 104 and two rear wheels 108 has been shown, it may be contemplated that another wheel 104 and another two wheels 108 lies on a laterally opposite side of the work machine 100, a side extending into the plane of the illustration.

A movement of the traction devices (i.e., a rotation of the set of front wheels 104 and the set of rear wheels 108) may be powered by a power source housed in a power compartment 112 of the work machine 100. The power source may be a gasoline engine, diesel engine, or any other engine capable of running on solid, liquid or gaseous fuels. In an alternate embodiment, the movement of the traction devices may be powered by other power sources, such as, electric motors powered by fuel cells or batteries. Further, the work machine 100 may include a main frame portion 114 and a sub-frame portion 116. The sub-frame portion 116 may be movable relative to the main frame portion 114.

To grade and level the materials 101, the work machine 100 may include an implement assembly in the form of a drawbar-circle-blade (DCB) arrangement 118 (referred to as a grader group 118). The grader group 118 may be supported by the sub-frame portion 116, and may include a drawbar 120, a circle member 122, and an implement 124 in the form of a moldboard.

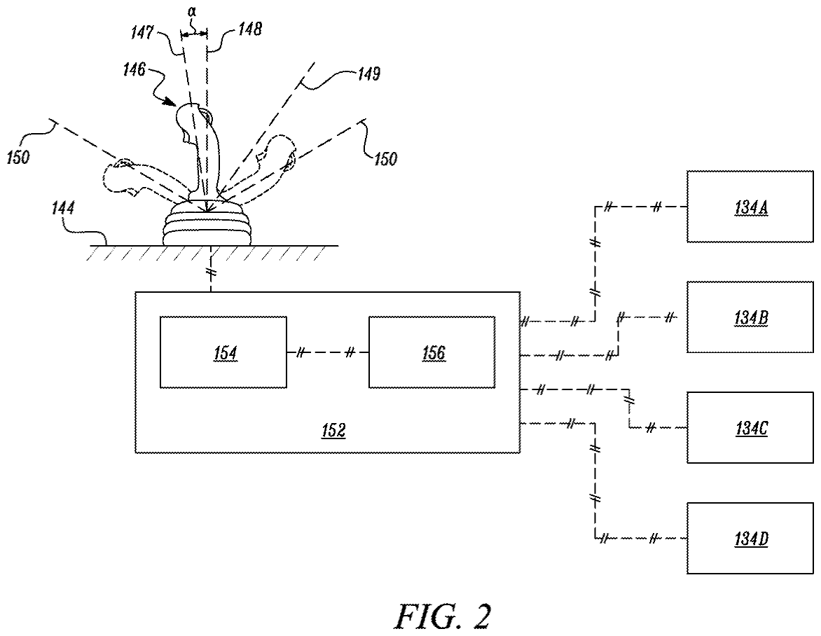

The drawbar 120 may include a first end 126 pivotally coupled to a front end portion 128 of the sub-frame portion 116 and a second end 130 movably supported by another portion (such as a mid-portion 132) of the sub-frame portion 116. For example, the second end 130 of the drawbar 120 may be coupled to the mid-portion 132 of the sub-frame portion 116 via one or more actuators, such as one or more hydraulic actuators 134A-B (FIG. 2). In an embodiment, the one or more hydraulic actuators 134A-B may include a lift cylinder 134A and a center shift cylinder 134B. The lift cylinder 134A may be actuated to raise or lower the second end 130 of the drawbar 120 with respect to the sub-frame portion 116, in turn allowing the grader group 118 to be raised or lowered relative to the work surface 102. The center shift cylinder 134B may be actuated to sideshift the second end 130 of the drawbar 120 with respect to the sub-frame portion 116, in turn allowing the grader group 118 to be sideshifted relative to the work surface 102.

The circle member 122 of the grader group 118 may rotate relative to the drawbar 120 about a rotation axis 136 that passes through a point proximal to a center of the circle member 122. The implement 124 may include a face 138. In an embodiment, the face 138 may be a concave face, that may help receive and agglomerate the materials 101 over the work surface 102, as shown in FIG. 1. As an example, the implement 124 may define an edge 140 at a bottom end (i.e., closer to the work surface 102) of the face 138 to help engage and scrape the materials 101 off the work surface 102 and distribute, level, and grade the work surface 102, during a grading operation.

The implement 124 may be coupled to the circle member 122 to rotate along with the rotation of the circle member 122 about the rotation axis 136. In an example, the implement 124 may be coupled to the circle member 122 via implement orientation control cylinders 134C. The implement orientation control cylinders 134C may be actuated to rotate the implement 124 with respect to the drawbar 120 about the rotation axis 136, in turn allowing the implement 124 to rotate relative to the work surface 102. In another example, the implement 124 may be coupled to the circle member 122 via an implement tip cylinder 134D. The implement tip cylinder 134D may be actuated to tilt the implement 124 with respect to the circle member 122, in turn allowing the implement 124 to tilt, forward or rearward, relative to the work surface 102.

Further, the work machine 100 may include an operator cab 142 supported on the sub-frame portion 116. The operator cab 142 may embody an area of the work machine 100 and may be configured to house an operator. The operator cab 142 may include an instrument panel 144 for operating the work machine 100 and various components installed therein. The instrument panel 144 may include one or more operator input devices 146, such as a joystick, a keyboard, a touch screen, a number pad, or any other suitable input device.

Referring to FIGS. 1 and 2, the operator input device 146 embodies a hand-operated joystick 146 configured to receive operator inputs. Based on the received inputs, the hand-operated joystick 146 controls movements of the implement 124. It is contemplated that the joystick 146 may control additional and/or different work tools/systems/components or functions of the work machine 100. For example, the joystick 146 may control work machine steering, work machine articulation, wheel tilt, a transmission function, an engine throttling function, and other functions of the work machine 100 known in the art.

In the embodiment illustrated, the joystick 146 has a first position. In an exemplary embodiment, the first position may be a neutral position 148 defined as a position where the joystick 146 stays at rest when no external force is applied thereon. The joystick 146 is configured to move from the neutral position 148 to another position when an external force is applied by the operator on the joystick 146 in order to provide input commands. The joystick 146 is configured to control the movements of the implement 124 based on a pre-defined operator input command. In particular, the joystick 146 may be tiltable about at least one axis. In an example, a forward-tilting progression of the joystick 146 may cause a portion of the implement 124 to lower towards the work surface 102. In another example, an aft-tilting progression of the joystick 146 may cause the portion of the implement 124 to raise (i.e. to move away from the work surface 102). In yet another example, a lateral-tilting progression of the joystick 146 may cause the implement 124 to shift towards the lateral direction relative to the operator's point of view perspective. For example, a right-tilting progression of the joystick 146, by the operator, may cause the implement 124 to move in a rightward direction relative to the operator's point of view. In another example, a left-tilting progression of the joystick 146 may cause the implement 124 to shift to the leftward direction relative to the operator's perspective. In yet another example, a twisting movement of the joystick 146 may cause the implement 124 to rotate about the rotation axis 136.

The joystick 146 may be configured to progress between the first position and a threshold position. In an exemplary embodiment, the threshold position (an extreme position 150) may be defined as a position of the joystick 146 beyond which the joystick 146 is unable to progress further. For example, referring to FIG. 2, the extreme position 150 is shown. It may be seen that the extreme position 150 is the position of the joystick 146 where a maximum angular displacement (in any direction i.e. forward, rearward, lateral, etc.) exists relative to the neutral position 148. While FIG. 2 illustrates two extreme positions 150, it may be contemplated that the joystick 146 may have multiple extreme positions 150 (along different directions). Also, the joystick 146 is configured to progress to any intermediate position between the neutral position 148 and the extreme position 150 to accordingly control the implement 124. Furthermore, the joystick 146 is biased to return to the neutral position 148, when the joystick 146 is not being manipulated (external force on joystick 146 is released/removed), or when released from any position other than the neutral position 148.

The joystick 146 may be in communication with an implement positioning system 152. The implement positioning system 152 is configured to control the position and movement of the implement 124 during operation. The implement positioning system 152 may include one or more sensors 154 and a controller 156. The one or more sensors 154 are configured to sense a plurality of operator input commands and a plurality of machine parameters associated with the work machine 100, and responsively generate electrical signals. Based on the electrical signals generated by the one or more sensors 154, the implement positioning system 152 automatically or semi-automatically controls the position and movement of the implement 124 during operation.

The sensors 154 may include, for example, input device sensors, cylinder position sensors, articulation sensors, and/or IMU sensors. It may be contemplated that the implement positioning system 152 may include other sensors known in the art, if desired. The input device sensors may sense the progression of the joystick 146 and responsively generate electrical operator command signals. In an example, the input device sensors preferably include a rotary potentiometer which produces a pulse width modulated signal in response to pivotal positions of the joystick 146. However, any sensor that is capable of producing an electrical signal in response to the pivotal positions of the joystick 146 may be implemented. The cylinder position sensors may sense the extension and retraction of at least one of the lift cylinders 134A, the center shift cylinder 134B, the implement orientation control cylinders 134C, and the implement tip cylinders 134D. The articulation sensor may sense the movement and relative positions of an articulation joint (not shown) associated with the work machine 100. The IMU sensors may sense an orientation of the work machine 100 with respect to true horizontal. For example, the IMU sensors preferably includes accelerometers, or gyroscopes, or magnetometers.

The controller 156 is communicably coupled to the sensors 154, so as to receive various electrical signals (such as signals associated with the progression of the joystick 146) from the sensors 154. Based on the electrical signals received, the controller 156 may control the actuation of at least one of the lift cylinders 134A, the center shift cylinder 134B, the implement orientation control cylinders 134C, and the implement tip cylinders 134D, which in turn may control the position and movement of the grader group 118. It should be appreciated that the controller 156 may readily embody a general machine microprocessor capable of controlling numerous machine functions. The controller 156 may include a memory, a secondary storage device, a processor, and any other components for running an application. Various other circuits may be associated with the controller 156 such as power supply circuitry, signal conditioning circuitry, solenoid driver circuitry, and other types of circuitry. The controller 156 is configured to detect movement of the joystick 146 when an external force is applied thereon. Further, the controller 156 is configured to determine a curve associated with the detected movement of the joystick 146. Based on the analysis of the detected movement, the controller 156 is configured to generate a signal for moving the actuators 134A, 134B, 134C, and 134D, thereby facilitating movement of the implement 124 based on pre-stored instructions stored in the memory of the controller 156. The controller 156 may also be configured to cease said movement of the implement 124 based on further analysis of the curve.

### INDUSTRIAL APPLICABILITY

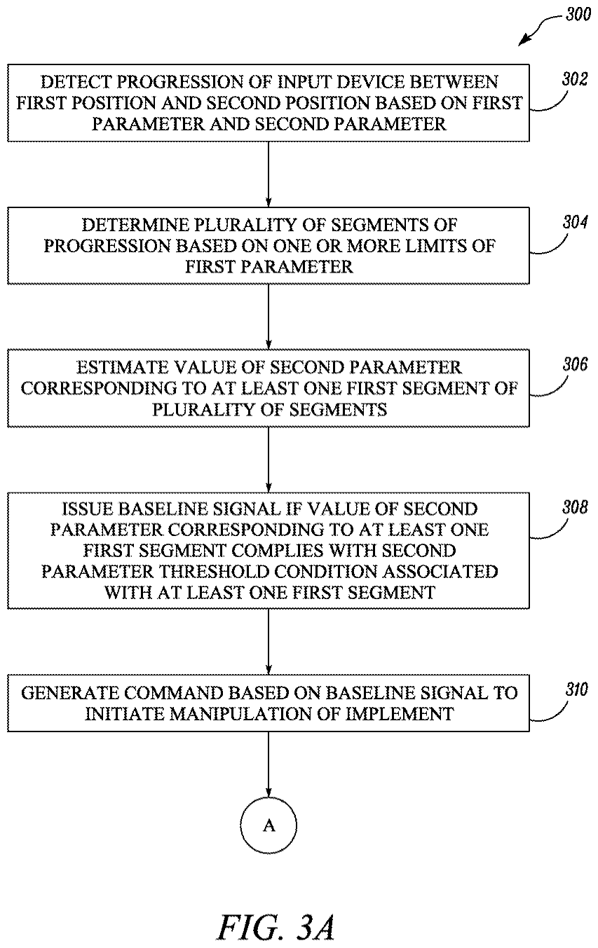

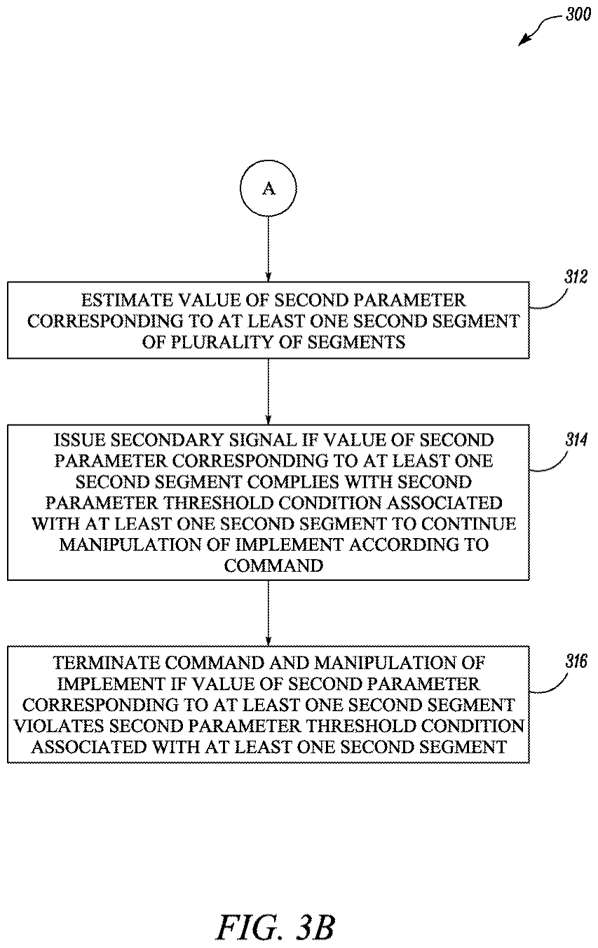

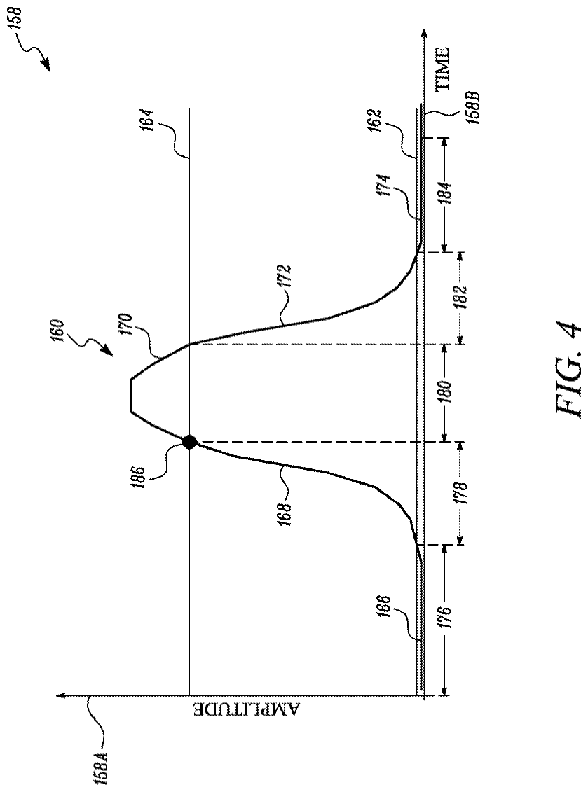

With reference to FIG. 3, an exemplary method for operating the implement 124 of the work machine 100, by the controller 156 will now be discussed. The method is discussed by way of a flowchart 300, as provided in FIG. 3, that illustrates exemplary stages (i.e., from 302 to 316) associated with the method. The method is discussed/explained in conjunction with FIGS. 4, 5, 6, and 7.

For the purpose of understanding of the ongoing disclosure, let us consider that the operator is operating the work machine 100 at a worksite having the work surface 102. During operation, the operator may move the input device i.e. the joystick 146 provided within the operator cab 142 of the work machine 100. The controller 156 may detect this progression/movement of the input device i.e. the joystick 146 movement between the first position and a second position. The progression of the joystick 146 may be defined as a movement of the joystick 146 from the first position to another position, in any possible direction (front, rear, lateral, or any other), generated by the application of external forces on the joystick 146.

For the purpose of better understanding of ongoing disclosure, it may be assumed that the second position may be the threshold position (in the direction of travel) of the joystick 146 i.e. the position beyond which the joystick 146 may not be able to move any further. Furthermore, it may be assumed that the progression of the joystick 146 corresponds to the movement of the joystick 146 from the first position to the second position and back to the first position.

After detecting the progression, the controller 156 detects the said progression of the joystick 146 based on a first parameter and a second parameter (stage 302). The first parameter may correspond to an amplitude and the second parameter may correspond to a time interval. More specifically, the first parameter/amplitude may correspond to a magnitude/value of the electrical signal generated by the sensors 154 during the progression of the joystick 146. In the embodiment illustrated, the amplitude of the electrical signal may be zero or may be negligible (minimum value) in cases where the joystick 146 is at the neutral/first position 148. The amplitude of the electrical signals may be of a maximum value in cases where the joystick 146 is at the extreme position 150, irrespective of the direction of progression (as shown in FIG. 2). It may be contemplated that the value of the electrical signal generated when the joystick 146 is at any intermediate position between the first position and the second position may be proportional to the angular displacement of the intermediate position from the neutral position 148. The second parameter/time interval may correspond to a time period i.e. time taken during the progression of the joystick 146. It may be contemplated that the sensors 154 associated with the joystick 146 collect the position and the direction of movement of the joystick 146, and, thereafter, relay or transmit the collected/detected data to the controller 156.

For the exemplary scenario under consideration, the progression of the joystick 146, is shown in an exemplary graphical representation 158 (FIG. 4) in the form of a curve 160. More particularly, in the embodiment illustrated, the controller 156 detecting the said progression of the joystick 146 based on the first parameter and the second parameter implies plotting a 2D curve for the progression with the first parameter and the second parameter. The first parameter is plotted along a vertical axis 158A (Y-axis), and the second parameter is plotted along a horizontal axis 158B (X-axis). Once the progression of the input device 146 is detected in the form of the curve 160, the controller 156 determines a plurality of segments of the curve 160 based on one or more limits of the first parameter (Stage 304). The one or more limits may correspond to a pre-defined threshold value/magnitude of the amplitude associated with the operator input command signals. The one or more limits may be pre-stored in the memory of the controller 156. In an exemplary embodiment, the one or more limits may include a first limit 162 corresponding to an amplitude associated with a position 147 (referred to as the maximum deadband position) of the joystick 146 adjacent to the neutral position 148, and a second limit 164 corresponding to an amplitude associated with an automatic implement manipulation position 149. The position 147 of the joystick 146 adjacent to the neutral position 148 corresponds to the position of joystick 146 at an angular displacement α (for example 0<α<5). Further, the automatic implement manipulation position 149 may correspond to a position, that exists between the first position 148 and extreme position 150 such that the angular displacement between the automatic implement manipulation position 149 and the extreme position is β (0<β<20).

Based on the first limit 162 and the second limit 164, the controller 156 segregates the curve 160 into five segments 166, 168, 170, 172, and 174. In an embodiment, the segment 166 is a portion of the curve 160 which lies below the first limit 162 (in FIG. 4) i.e. the segment 166 may correspond to a portion of the progression of the joystick 146 when the joystick 146 is moved from the neutral position 148 to the position 147. The segment 168 is a portion of the curve 160 that ascends from the first limit 162 to the second limit 164 i.e. the segment 168 may correspond to a portion of the progression when the operator moves the joystick 146 from the position 147 to the automatic implement manipulation position 149. The segment 170 is a portion of the curve 160 that ascends beyond the second limit 164, reaches a maximum amplitude, and descends back to the second limit 164 i.e. the segment 170 may correspond to a portion of the progression when the operator moves the joystick 146 beyond the automatic implement manipulation position 149 to the second position 150, and releases the joystick 146 to move back to the automatic implement manipulation position 149. The segment 172 is a portion of the curve 160 which descends from the second limit 164 back to the first limit 162 i.e. the segment 172 may correspond to a portion of the progression when the joystick 146 returns from the automatic implement manipulation position 149 back to the position 147. The segment 174 is a portion of the curve 160 that lies below the first limit 162 i.e. the segment 174 may correspond to a portion of the progression when the joystick 146 moves from the position 147 to the neutral position 148.

In the exemplary scenario, at least one segment of the segments 166 and 168 may define first segment of the curve 160, and at least one segment of the segments 170, 172, and 174 may define second segment of the curve 160. In an exemplary embodiment, the second segment may be successive to the first segment. While the first parameter includes two limits, leading to formation of five segments in the curve 160, in other embodiments it may be contemplated that the first parameter may include more limits, leading to segregation of the curve 160 (by the controller 156) into any other possible number of segments.

The controller 156 now moves to stage 306. At stage 306, the controller 156 estimates a value of the second parameter (time period) corresponding to at least one first segment of the plurality of segments. More specifically, the controller 156 estimates the time periods 176 and 178 corresponding to segments 166 and 168 of the curve 160. The time period 176 may be a time interval in which the curve 160 remains below the first limit 162. For example, the time period 176 may correspond to the time interval in which the joystick 146 rests at the neutral position 148 and moves up to 5 degrees from the neutral position 148 to the position 147 during the progression. The time period 178 may be a time interval in which the amplitude/first parameter associated with the curve 160 ascends from the first limit 162 to the second limit 164. For example, the time period 178 may correspond to the time interval in which the operator moves the joystick 146 from the position 147 to the intermediate automatic manipulation position 149 associated with the second limit 164.

The method moves to stage 308 where the controller 156 compares the estimated value of the second parameter, i.e. the time periods 176 and 178, associated with the segments 166 and 168, with their corresponding second parameter threshold conditions (the second parameter threshold conditions being the time values/magnitudes pre-stored within the memory of the controller 156). In an embodiment, the second parameter threshold condition (T1) corresponding to the segment 166 is defined as a minimum time that the operator should take for moving the joystick 146 from the neutral position 148 to the position 147, and the second parameter threshold condition (T2) corresponding to the segment 168 is defined as a maximum permissible time that can be taken for moving the joystick 146 from the position 147 to the automatic implement manipulation position 149 associated with the second limit 164 to actuate automatic manipulation of the implement 124. More simply, time period 176≥T1 and time period 178≤T2 are the required conditions to actuate automatic manipulation of the implement 124 by the controller 156.

If the value of the second parameter corresponding to the at least one first segment complies with the second parameter threshold condition associated with the at least one first segment, a baseline signal is issued. For the purpose of better understanding of stage 308, exemplary situations and numerical values will be taken. While the time values have been taken with milliseconds as the unit of measurement, it may be contemplated that any other unit may be used. Let it be assumed that:

the time period 176 is 5 milliseconds;

the time period 178 is 7 milliseconds;

the value of the second parameter threshold condition corresponding to the segment 166 stored in the controller 156 is 4 milliseconds; and

the value of the second parameter threshold condition corresponding to the segment 168 stored in the controller 156 is 7.5 milliseconds.

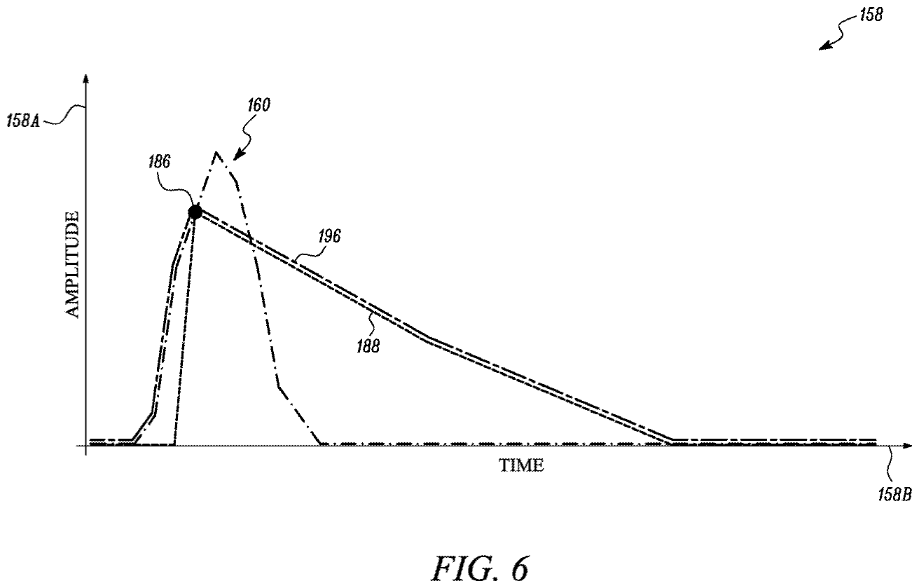

In the exemplary scenario, the controller 156 determines that the time period 176 is greater than the value of the second parameter threshold condition (T1) corresponding to the segment 166 stored in the controller 156. Further, the controller 156 determines that the time period 178 is less than the value of the second parameter threshold condition (T2) corresponding to the segment 168 stored in the controller 156. Thus, the second parameter for at least one first segment complies with the second parameter threshold condition. Accordingly, the controller 156 issues the baseline signal. The baseline signal may correspond to the manipulation of the implement 124 based on pre-stored instructions within the controller 156. Till the baseline signal is issued by the controller 156, the implement 124 is moved based on the operator's input on the input device/joystick 146. The method now moves to stage 310, at which the controller 156, based on the baseline signal, generates a command to initiate manipulation of the implement 124, as shown by a curve 188 in FIG. 6. The curve 188 defines a time-variable magnitude/value of the first parameter/amplitude of the electrical signal corresponding to the implement manipulation command generated by the controller 156. Once the controller 156 operates the implement 124 based on the pre-stored commands, the control of the implement 124 is facilitated by the controller 156 instead of the operator.

The method now proceeds to stage 312 where the controller 156 estimates a value of the second parameter (time period) corresponding to at least one second segment of the plurality of segments. More specifically, the controller 156 estimates the time periods 180, 182, and 184 corresponding to the respective segments 170, 172, and 174 of the curve 160. The time period 180 may correspond to the time interval in which the curve 160 ascends beyond the second limit 164 towards the extreme position 150, remains at the extreme position 150, and descends back to the second limit 164 i.e. the operator moves the joystick 146 beyond the automatic implement manipulation position 149 to the second position 150, and back to the automatic implement manipulation position 149. The time period 182 may be a time interval in which the curve 160 descends below the second limit 164 towards the first limit 162 i.e. the joystick 146 moves from the automatic implement manipulation position 149 to the position 147. The time period 184 may be a time interval in which the curve 160 lies below the first limit 162 i.e. the joystick 146 moves from the position 147 to the neutral position 148.

After estimating the said time periods, the method moves to stage 314. At stage 314, the controller 156 compares the estimated value of the second parameter, i.e. the time periods 180, 182, and 184, associated with the segments 170, 172, and 174 of the second segment, with their corresponding second parameter threshold conditions. The second parameter threshold conditions corresponding to the segments 170, 172, and 174 are pre-stored in the memory of the controller 156. In the embodiment illustrated, the second parameter threshold condition corresponding to the segment 170 is defined as the range of acceptable time intervals (T3) for the joystick 146 (to move beyond the automatic implement manipulation position 149 to the second position 150 and return from the second position 150 back to the automatic implement manipulation position 149) for facilitating continuation of the automatic manipulation of the implement 124. More simply, T3 is the range of time values (first acceptable value<=T3<=second acceptable) for facilitating continuation of automatic manipulation of the implement 124.

The second parameter threshold condition corresponding to the segment 172 is defined as a maximum permissible time (T4) for the joystick 146, to return from the automatic implement manipulation position 149 to the position 147, for facilitating continuation of automatic manipulation of the implement 124. The second parameter threshold condition corresponding to the segment 174 is defined as a minimum time required (T5) to be taken for the joystick 146, to return to the neutral position 148 from the position 147, for facilitating continuation of automatic manipulation of the implement 124.

If the value of second parameters i.e. time periods 180, 182, and 184 complies with their corresponding second parameter threshold conditions, the controller 156 issues a secondary signal to generate a command to continue manipulation of the implement 124. For the purpose of better understanding of the ongoing stage, exemplary values and ranges for time periods and thresholds will be taken. Let it be assumed that:

the time period 180 is 5 milliseconds;

the time period 182 is 7 milliseconds;

the time period 184 is 9 milliseconds;

the second parameter threshold condition corresponding to the segment 170 stored in the controller 156 is that the time period 180 should be in the range 3-8 milliseconds (including 3, 4, 5, 6, 7 and 8 milliseconds);

the value of the second parameter threshold condition corresponding to the segment 172 stored in the controller 156 is 8.5 milliseconds; and

the value of the second parameter threshold condition corresponding to the segment 174 stored in the controller 156 is 5 milliseconds.

In the exemplary scenario, the controller 156 determines that the time period 180 lies in the range of values associated with the second parameter threshold condition corresponding to the segment 170 stored in the controller 156. Further, the controller 156 determines that the time period 182 is less than the value of the second parameter threshold condition corresponding to the segment 172 stored in the controller 156. Further, the controller 156 determines that the time period 184 is more than the value of the second parameter threshold condition corresponding to the segment 172 stored in the controller 156. Thus, the second parameter for at least one second segment complied with the second parameter threshold condition. Accordingly, the controller 156 issues a continuation signal i.e. a signal to continue manipulation of the implement 124 according to the baseline signal command.

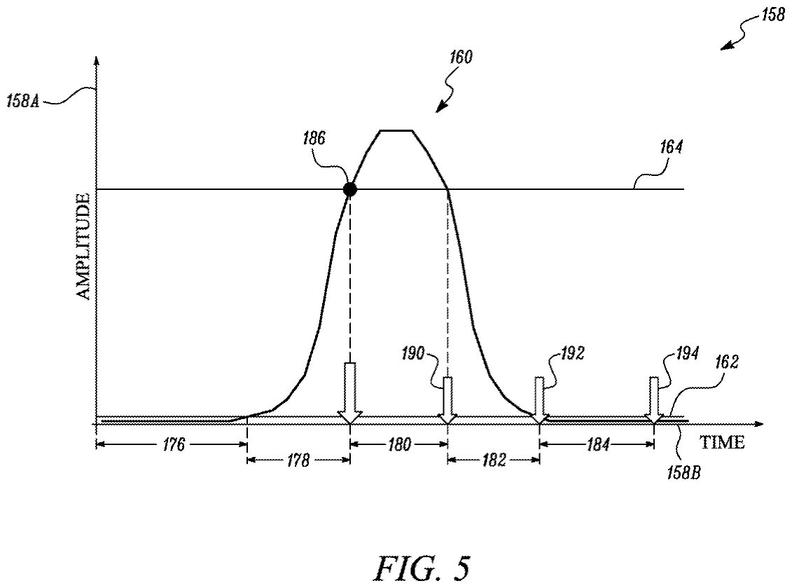

However, if the second parameter for at least one second segment does not comply with the second parameter threshold condition, the controller 156 proceeds to stage 316. At said stage, the controller 156 terminates the command and manipulation of the implement 124 if the estimated value of the second parameter corresponding to the at least one second segment violates their corresponding second parameter threshold conditions. For example, the controller 156 may validate if the time period 180 fulfils the corresponding second parameter threshold conditions associated with the segment 170. In case, the estimated time period 180 associated with segment 170 violates the corresponding second parameter threshold conditions, the controller 156 may activate a first invalid flag signal 190 (FIG. 5), and accordingly generate a command to terminate the automatic manipulation of the implement 124. For example, in case, if the operator raises or lowers the joystick 146 beyond the automatic implement manipulation position 149 and holds the joystick 146 for a time period greater than the threshold time period corresponding to the segment 170, the controller 156 may activate the first invalid flag signal 190 and accordingly may generate the command to terminate the automatic manipulation of the implement 124. In such case, the controller 156 relinquishes the control of the implement 124, and the operator now controls the movement of the implement 124.

Similarly, once the command for automatic manipulation of the implement 124 is triggered and the time period 180 fulfils the corresponding second parameter threshold condition, the controller 156 may next validate if the time period 182 meets the corresponding second parameter threshold condition. In case, if the estimated time period 182 violates the corresponding second parameter threshold condition, the controller 156 may activate a second invalid flag signal 192 (FIG. 5), and accordingly may generate a command to terminate the automatic manipulation of the implement 124. In a similar vein, once the command for the automatic manipulation of the implement 124 is triggered and the time periods 180 and 182 fulfils their corresponding second parameter threshold conditions, the controller 156 may validate if the time period 184 meets the corresponding second parameter threshold condition. In case, if the estimated time period 184 violates the corresponding second parameter threshold condition, the controller 156 may activate a third invalid flag signal 194 (FIG. 5), and accordingly generate a command to terminate the automatic manipulation of the implement 124.

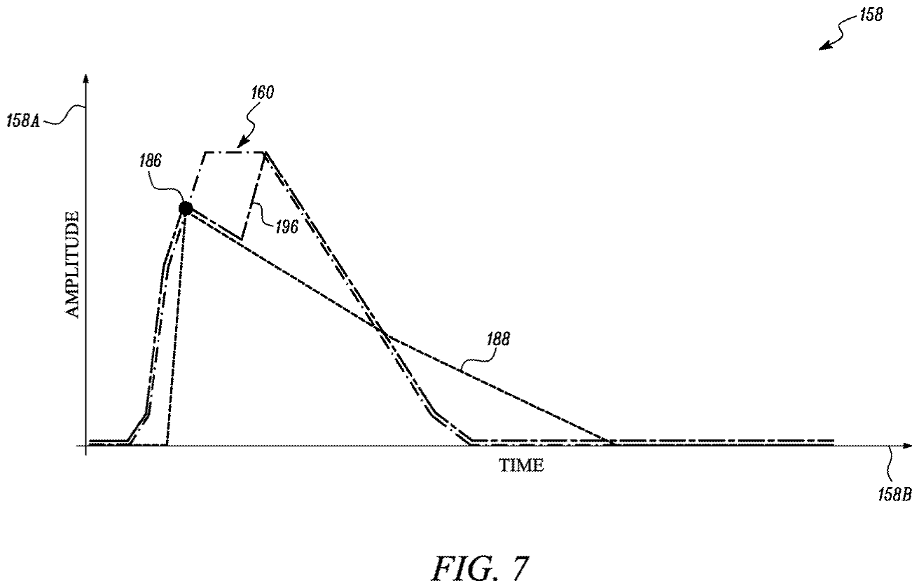

In an aspect of the present disclosure, between the stages 308 and 316, the controller 156 may perform command arbitration i.e. choose a particular mode of operation of the implement 124 over the other. The particular mode of operation of the implement 124 includes operator operated implement mode and automatically operated implement mode (based on pre-stored instruction in the memory of the controller 156). Thus, command arbitration may be defined as choosing one particular mode of operating the implement 124 over another mode of operating the implement 124. The detailed explanation of how the command arbitration is performed will now be discussed in detail with reference to FIGS. 6 and 7 and exemplary scenarios.

Let us consider the scenario where at stage 308, the controller 156 detects that the joystick 146 is moved to the automatic implement manipulation position 149 within time periods 176 and 178 that comply with the corresponding second parameter threshold conditions. Till the joystick reaches the automatic implement manipulation position 149, the controller 156 selects the operator operated implement mode as a default mode for operating the implement 124 (as shown in the form of a curve 196 in FIGS. 6 and 7). In such a scenario, the controller 156 may generate an arbitrate command signal i.e. the controller 156 issues the baseline signal (stage 310), at point 186 in the curve 160, to actuate automatic implement manipulation (curve 188). More specifically, the controller 156 may generate the arbitrate command signal, thereby switching the mode of operation of the implement 124 i.e. switching from the operator operated implement mode to the automatically operated implement mode (based on pre-stored instructions in the controller 156).

The controller 156, at stage 312, may validate if the joystick 146 remains at or beyond the automatic implement manipulation position 149 for the time period 180 complying with the corresponding second parameter threshold condition. If the time period 180 complies with the corresponding second parameter threshold condition, the controller 156 continues the automatic implement manipulation.

However, in case, if the controller 156 detects that at least one of the time periods 180, 182, and 184 violates their corresponding second parameter threshold conditions, the controller 156 may perform command arbitration i.e. switch the mode of operation of the implement 124 i.e. switching from the automatically operated implement mode (based on pre-stored instructions in the controller 156) to the operator operated implement mode as can be seen in FIG. 7 (the curve 196 shifts from the automatic implement control (curve 188) to the operator implement control (curve 160) i.e. the operator operates the implement 124 now).

It will be apparent to those skilled in the art that various modifications and variations can be made to the system of the present disclosure without departing from the scope of the disclosure. Other embodiments will be apparent to those skilled in the art from consideration of the specification and practice of the system disclosed herein. It is intended that the specification and examples be considered as exemplary only, with a true scope of the disclosure being indicated by the following claims and their equivalent.

What is claimed is:

1. A method for operating an implement of a work machine, the method comprising:
detecting, by a controller, a progression of an input device between a first position and a second position based on a first parameter and a second parameter;
determining, by the controller, a plurality of segments of the progression based on one or more limits of the first parameter;
estimating, by the controller, a value of the second parameter corresponding to at least one first segment of the plurality of segments;
issuing, by the controller, a baseline signal if the value of the second parameter corresponding to the at least one first segment complies with a second parameter threshold condition associated with the at least one first segment;
generating, by the controller, a command based on the baseline signal to initiate manipulation of the implement;
estimating, by the controller, a value of the second parameter corresponding to at least one second segment of the plurality of segments, wherein the at least one second segment is successive to the at least one first segment;
issuing, by the controller, a secondary signal if the value of the second parameter corresponding to the at least one second segment complies with a second parameter threshold condition associated with the at least one second segment to continue manipulation of the implement according to the command; and
terminating, by the controller, the command and the manipulation of the implement if the value of the second parameter corresponding to the at least one second segment violates the second parameter threshold condition associated with the at least one second segment.
